(19) United States
(12) Patent Application Publication
(10) Pub. No.: US 2006/0105656 A1
(43) Pub. Date: May 18, 2006

(54) COPPER VERMICULITE THERMAL COATING

(76) Inventor: James E. White, Greenwich, OH (US)

Correspondence Address: HAHN LOESER & PARKS, LLP, One GOJO Plaza, Suite 300, AKRON, OH, 44311-1076, US

(21) Appl. No.: 11/163,823

(22) Filed: Nov. 1, 2005

Related U.S. Application Data
(60) Provisional application No. 60/623,952, filed on Nov. 1, 2004.
(60) Provisional application No. 60/624,778, filed on Nov. 3, 2004.

(51) Int. Cl. B32B 5/02; B32B 17/02; B32B 27/12; B05D 3/02; B05D 1/18

(52) U.S. Cl. 442/131; 442/172; 442/180; 427/430.1; 427/372.2

(57) ABSTRACT

An improved insulating material and method is provided by a vermiculite and copper coating. The coating may be used in a variety of applications including on a thermal fabric such as a porous fiberglass fabric made of texturized yarn. The coating fuses with the fiberglass fabric at elevated temperatures. The coating allows improved dispersion of heat over that of prior art vermiculite coated fiberglass fabric.

This application claims the benefit of U.S. provisional patent application Ser. No. 60/623,952, filed Nov. 1, 2004 and U.S. provisional patent application Ser. No. 60/624,778, filed Nov. 3, 2004, both herein incorporated by reference.

### TECHNICAL FIELD

This invention relates to a copper and vermiculite refractory coating and, more particularly, it relates to a copper and vermiculite refractory coating of a porous base fabric used to manufacture a tape for insulation applications such as automotive exhaust pipes and the like.

### DESCRIPTION OF THE PRIOR ART

Fiberglass fabric is a common insulating material used to manufacture heat resistant, flexible, insulating fabric tape that is commonly used as an insulation wrapping for engine exhaust systems as well as other automotive and industrial applications. These fiberglass fabric tapes are typically capable of withstanding a continuous 1000 degrees F. The heat resistance of the fiberglass fabric tape can be improved by coating the tape with a performance enhancer such as Vermiculite to increase the maximum continuous exposure temperature up to 1500 degrees F. Vermiculite is clay mineral that a three layered structure with a MgO 6 H₂O layer between sheets. When vermiculite is heated to a temperature of around 660 degrees F. it begins to shrink. At above 750 degrees F. the combined water in the material is released and it exfoliates. In this process vermiculite will swell to 10-20 times its original volume. Exfoliated vermiculite has a very low thermal conductivity making it an excellent insulating material. An example of such a vermiculite coated fiberglass fabric tape product is sold under the trade name THERMO-SPEC™ 1500 and manufactured by Thermo Tex Industries, Inc. of Greenville, S.C.

Regardless of the performance enhancers, all vermiculite-coated fiberglass fabric tapes are generally limited to service temperatures of 1500 degrees F. or less. It would therefore be an advantage to provide a vermiculite-coated fiberglass fabric tape having a service temperature significantly above the 1500 degree F. service temperature limitation of prior art vermiculite-coated fiberglass fabric tapes.

### SUMMARY OF THE INVENTION

The present invention provides an insulating material comprising a base fabric; and a refractory coating comprising vermiculite and at least one material having a thermal conductivity coefficient of at least 50 (W/m K) at about 1000 K, the refractory coating formed on the surface and interstices of the fabric, the refractory coating being capable of fusing with the base fabric at elevated temperatures above 750 degrees F.

The present invention further provides method of manufacturing an insulating material comprising the steps of: providing a fabric; providing a vermiculite and copper dispersion; immersing the fabric in the vermiculite and copper dispersion; and drying the coated fabric.

The present invention also provides a refractory coating comprising vermiculite and copper. These and other advantages will be apparent upon a review of the detailed description of the present invention.

### BRIEF DESCRIPTION OF THE DRAWINGS

FIG. 1 is a drawing of a base fabric coated with a refractory coating in accordance with an embodiment of the present invention;

FIG. 2 is drawing of the coated fabric of the present invention used as a thermal wrap on a pipe; and

FIG. 3 is a flow chart of the method for making a base fabric coated with a refractory coating in accordance with an embodiment of the present invention.

### DETAILED DESCRIPTION OF THE INVENTION

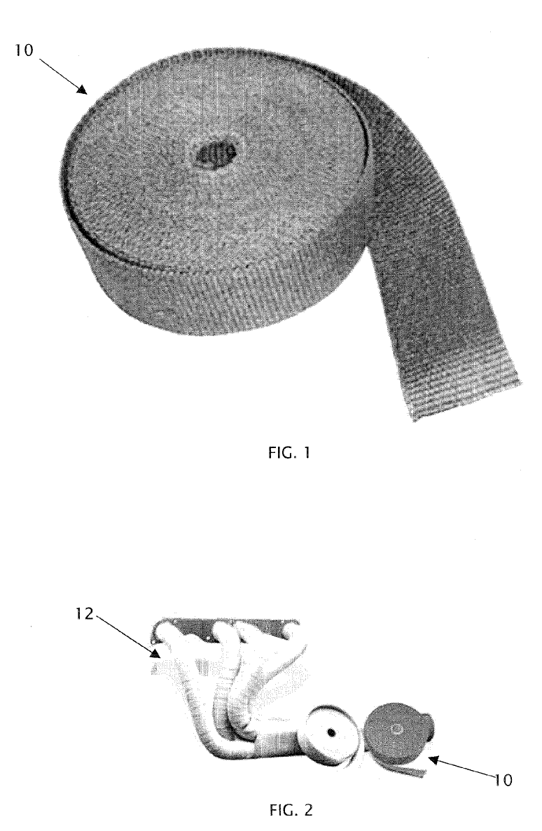

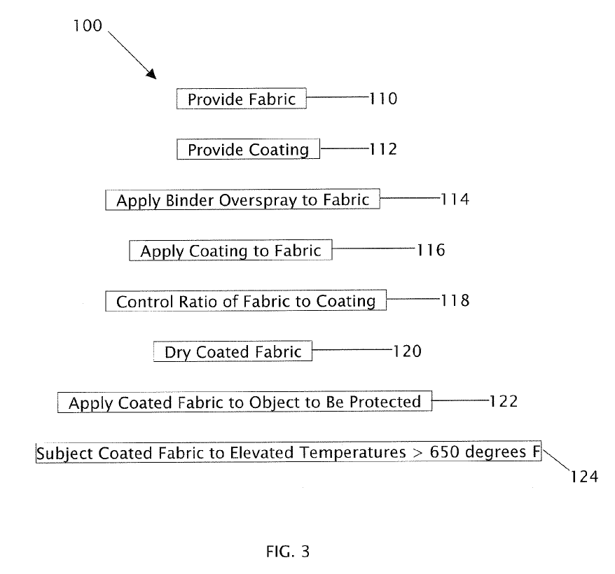

Referring now to FIGS. 1-3, wherein FIG. 1 shows a coated fabric 10 in accordance with a first embodiment of the invention. The coated fabric 10 may be applied as a thermal wrap to an object such as exhaust pipes 12 as shown in FIG. 2. The method 100 of producing the coating of the present invention is shown in FIG. 3. The method 100 of production of the present invention begins providing an object to be coated such as a heat resistant fabric such as a fiberglass fabric tape 110. The heat resistant fabric tape may be constructed of a woven fiberglass base fabric having warp and fill yarns. As will be understood by those skilled in the art, the fiberglass substrate fabric, though preferably formed of all fiberglass yarns, may be constructed with other kinds of heat and fire resistant yarns. The substrate or porous base fabric may also be knit or non-woven.

As used herein the term “fabric” includes materials that are woven, knitted, felted, fused, non-woven or otherwise constructed from fibers. Since the base fabric must have a porosity there must be an openness to the texture of the fabric so as to permit the refractory coating to impregnate the surface of the fabric and fill, at least partially, some, if not all, of the interstices of the porous fabric.

In one embodiment, the process for producing the present invention involves weaving of the fabric tape from highly texturized fiberglass yarns. This process may be accomplished on high-speed needle looms using an overspray binder 114 that will be compatible with the coating and will help maintain the bulk characteristic of the texturized yarn. Such overspray binders are known in the industry.

The fiberglass fabric tape is then coated 116. The coating provided comprises a mixture of Vermiculite and copper particles 114. The copper particles are typically in a size range of 28-35 microns and provided in a dispersion, however, it is contemplated that other particle sizes may be adequate. An example of a suitable Copper material is BX 9050 Copper manufactured by US Bronze Particles, Inc of New Jersey. An example of a suitable Vermiculite material is HTS-XE Vermiculite manufactured by W.R. Grace. A suitable mixture of the compounds has been found in a ratio of about 9 parts vermiculite to 1 part copper, or more precisely, a mixture composition of 89.5% vermiculite and 10.5% copper.

In one embodiment the fiberglass fabric tape coated by immersion in the vermiculite-copper mixture. Metering rolls/high-pressure roll pads are used to control the fabric to coating ratio during the impregnation of the vermiculite-copper mixture to the fiberglass fabric and to ensure proper impregnation and add-on of the coating 118.

The next step involves drying of the coated fabric tape 120. Drying the coated fabric tape may be achieved by any of a number of procedures. Temperatures of about 250 degrees F. are usually effective, although lower or higher temperatures may be employed, where desired. An infrared source of heat has been found effective. Equally useful is a stream of forced dry air. Passing the prepared fabric tape through a drying oven in a continuous fashion is an effective drying technique where the fabric tape composition is being prepared in a continuous operation. The vermiculite-copper coating is bonded in the interstices as well as bonded to the surface of the base fabric, such that a significant amount of the fabric's flexibility and stretch properties are retained.

When this vermiculite-copper coated fabric composition is exposed to heat and high temperatures above 750 degrees 124, the refractory materials fuse into the softened surface of base fabric, enabling it to withstand intense heat and elevated temperatures well beyond the normal melt temperature of the fiberglass fabric. The resulting fabric structure will have improved qualities and will not soften, melt, drip or lose its insulating properties. The vermiculite-copper coated fabric tape of the present invention has been heat tested and has shown a heat resistance improvement of up to 30% over the service life of prior art vermiculite coated fabric tape (up to 2000 degrees F.).

The tape may be used as an exhaust wrap 122. Exhaust systems present a difficult heating cycling environment and are typically plagued by hot spots inherent in their design—especially at 90 degree elbows and other bends where the exhaust is directly striking a wall of the exhaust pipe. This presents a problem for exhaust wraps that are unable to dissipate the heat. The hot spots have a tendency to break down the exhaust wrap tapes and result in a cracking point. The vermiculite coating of vermiculite coated fiberglass tapes helps to slightly dissipate the heat. By adding the copper material to the vermiculite coating, the copper helps increase the heat dissipation of the wrap so that heat is transferred by conduction away from the hot spots to other cooler areas of the exhaust system providing an even type of cooling process for the hot spots. This provides a significant advantage over prior art wraps and provides a longer lasting wrap as well as providing a wrap that can handle higher peak temperatures by dissipating the heat prior to any damage.

The addition of copper to the vermiculite increases the service life of the fabric. It is contemplated that other materials may be used with vermiculite in a similar manner. The added material needs to have good thermal conductivity. It is also desired that the material is relatively inexpensive so as to not add significantly to the cost of production such that it will compete with non-fiberglass based fabrics. The thermal conductivity of a material is equivalent to the quantity of heat that passes in unit time through unit area of a plate, when its opposite faces are subject to unit temperature gradient (e.g. one degree temperature difference across a thickness of one unit). Thermal conductivity=Heat flow rate÷(Area×Temperature gradient). Thermal conductivity changes with temperature. For most materials it decreases as the temperature rises. It is contemplated that other materials besides copper having a high thermal conductivity at elevated temperatures may also be used in the present invention. Pure copper has a thermal conductivity coefficient of 352 watts per meter Kelvin (W/m K) at about 1000 K (1472 degrees F.). It is contemplated that a suitable material has a thermal conductivity coefficient of at least 50 (W/m K) at about 1000 K and preferably above 200 (W/m K) at about 1000 K.

Although presented as a pipe or exhaust wrap tape, the present invention may have a variety of uses as protective mats and curtains in welding operations, as linings for fire resistant machine and appliance covers, or as duct insulation and the like, just to name a few.

The refractory coating of the present invention is not limited to use on fabric. It is anticipated that the refractory coating of the present invention can be used in any suitable application where thermal protection is needed.

While this invention has been described with reference to preferred embodiments thereof, it shall be understood that such description is by way of illustration and not by way of limitation. Accordingly, the scope and content of the present invention are to be defined only by the terms of the appended claims.

What is claimed is:

1. A refractory coating comprising vermiculite and copper.

2. The coating of claim 1 wherein the refractory coating is generally about 9 parts vermiculite and 1 part copper.

3. The coating of claim 1, wherein the copper is provided as particles generally in a size range of 28-35 microns.

4. An insulating material comprising:
a base fabric; and
a refractory coating comprising vermiculite and at least one material having a thermal conductivity coefficient of at least 50 (W/m K) at about 1000 K, the refractory coating formed on the surface and interstices of the fabric, the refractory coating being capable of fusing with the base fabric at elevated temperatures above 750 degrees F.

5. The material of claim 4 wherein the at least one material having a thermal conductivity coefficient of at least 50 (W/m K) at about 1000 K is copper.

6. The material of claim 4 wherein the base fabric is a porous fiberglass fabric made from a texturized fiberglass yarn.

7. The material of claim 5 wherein the refractory coating is generally about 9 parts vermiculite and 1 part copper.

8. The material of claim 5 wherein the refractory coating is provided as a dispersion.

9. The material of claim 5, wherein the copper of the refractory coating is provided as particles generally in a size range of 28-35 microns.

10. The material of claim 5, wherein the refractory coating comprising at least 10% copper particles generally in a size range of 28-35 microns.

11. A method of manufacturing an insulating material comprising the steps of:
providing a fabric;
providing a vermiculite and copper dispersion;
immersing the fabric in the vermiculite and copper dispersion; and
drying the coated fabric.

12. The method of claim 11 further comprising the step of:
subjecting the coated fabric to elevated temperatures above 750 degrees F. wherein the vermiculite and copper coating fuses with the fabric.

13. The method of claim 11 wherein the step of providing a vermiculite and copper dispersion comprises the step of:
forming a dispersion generally comprising 9 parts vermiculite to every 1 part copper.

14. The method of claim 11 further comprising the step of:
controlling the fabric to coating ratio during the impregnation of the vermiculite and copper coating using metering rolls or high-pressure roll pads to ensure proper impregnation and add-on of the coating.

15. The method of claim 11 further comprising the step of:
applying an overspray in the form of a specially formulated binder to the fabric prior to the step of immersing the fabric in the vermiculite and copper dispersion, the overspray providing retention of the bulk property of the fabric.

16. The method of claim 11 wherein the step of drying the coated fabric is accomplished by subjecting the fabric to a source of infrared heat or forced dry air at about 250 degrees F.

17. The method of claim 10 wherein the step of providing a fabric comprises the step of providing a porous fiberglass fabric made from a texturized fiberglass yarn.

18. The method of claim 10 wherein the step of:
providing a vermiculite and copper dispersion utilizes copper particles generally in a size range of 28-35 microns.

19. The method of claim 10 further comprising the step of:
wrapping the coated fabric around a pipe.

20. The method of claim 18 further comprising the step of:
subjecting the pipe and the coated fabric to elevated temperatures above 750 degrees F. wherein the vermiculite and copper coating fuses with the fabric.
